(19) United States
(12) Patent Application Publication
(10) Pub. No.: US 2010/0042933 A1
(43) Pub. Date: Feb. 18, 2010

(54) REGION SELECTION CONTROL FOR SELECTING BROWSER RENDERED ELEMENTS

(75) Inventor: BRIAN V. RAGUSA, PEMBROKE, MA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/192,987

(22) Filed: Aug. 15, 2008

(51) Int. Cl. G06F 3/048

(52) U.S. Cl. 715/760

(57) ABSTRACT

An initial point within a browser interface corresponding to a displayed pointer location can be identified. A terminal point within the browser interface corresponding to a final position of the pointer can also be identified. A selection region can be defined by these points, where the initial point and the terminal point are diagonally opposing corners of the selection region. A set of browser elements (e.g., HTML elements) can be searched for elements that are defined by the selection region to produce a set of resulting browser elements. The set of resulting browser elements can be marked as having been selected by a user. Thus, a user can use a definable rectangular region to select a set of browser elements.

### BACKGROUND OF THE INVENTION

The present invention relates to the field of user interface controls and, more particularly, to region selection control for selecting browser rendered elements.

Many different mechanisms exist within graphical user interfaces (GUI) interfaces to permit a user to make selections. These selections can be used in conjunction with a number of programmatic actions involving the selected content. Cut, Copy, Move, and Delete are a few of the programmatic actions, which operate against selected text, pictures, files, or other objects.

At present, item selection tools available within Web browsers for rendered content are relatively rudimentary. The two principle tools are a snapshot tool and a text selection tool. The snapshot tool captures an image of a user selected region in some image format, which is generally placed in a clipboard memory.

The text selection tool permits a user to select a text segments. Selection made via a text selection tool is usually based upon an insertion point and proceeds from that point to the right and downwards (or to the left and upwards depending on placement of a final point) from this insertion point. An attempt is made to copy a “complete line” of text starting at the insertion point, much as text is copied within a word processing document.

Conventional implementations of text selection tools can behave in user mystifying ways when selection actions are attempted from within Web pages containing many different HTML elements. Sometimes parts of different elements are added, tables and buttons having “weird” formatting are sometimes captured, and the like. Behavior of conventional text selection tools also can sometimes expand past formatting (e.g., when column formatting is used within a Web page), can sometimes stop within a region (e.g., can stop within a portlet of a portal page), and the like. Further, conventional text selection tools often capture images, animated elements of a Web page, and the like, which can result in peculiar results when programmatic actions not expecting the captured elements execute. Most users have experienced some variant of “abnormal” processing results when pasting content into a word processing document that was cut from a Web site.

One problem with conventional browser tools appears to be their inability to operate at a browser element level. That is, content selection tools of browsers do not permit users to select multiple elements in an intuitive fashion. Thus, captured content does not match user expectations, which causes results of operations based upon captured content to befuddle users.

### BRIEF DESCRIPTION OF THE SEVERAL VIEWS OF THE DRAWINGS

FIG. 1 is a diagram showing a use of a region selection control for selecting browser elements in accordance with an embodiment of the inventive arrangements disclosed herein.

FIG. 2 is a schematic diagram illustrating a system that implements a region selection control for browser elements within a graphical user interface in accordance with an embodiment of the inventive arrangements disclosed herein.

FIG. 3 is a flow chart showing a region selection method in accordance with an arrangement of the inventive arrangements disclosed herein.

### DETAILED DESCRIPTION OF THE INVENTION

The present invention discloses a region selection tool for browsers that is used to mark browser elements. Using the region selection tool, a user can define a rectangular region within a browser using a pointing device, such as a mouse. For example, a first point can be selected by pressing a mouse button, the mouse can be moved until a displayed pointer is at a desired position, and the mouse can be released, which defines a terminal point of the selection region. In this respect, defining a region is similar to many image capture (e.g., snapshot) controls. Unlike conventional controls, however, those browser elements (e.g., HTML elements) fully contained within the selection region are marked as selected. Other browser elements are not marked, such as elements only partially contained in the selection region. A group of selected browser elements can be modified (such as by holding a shift key) to permit additional elements to be added or removed from the group of marked browser elements. Programmatic actions (e.g., cut, copy, delete, paste, etc) involving the marked elements can them be performed. These programmatic actions can include locally executing inter-application actions involving a clipboard memory as well as remotely executing intra-application actions involving a Web server that provides content rendered in the browser.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

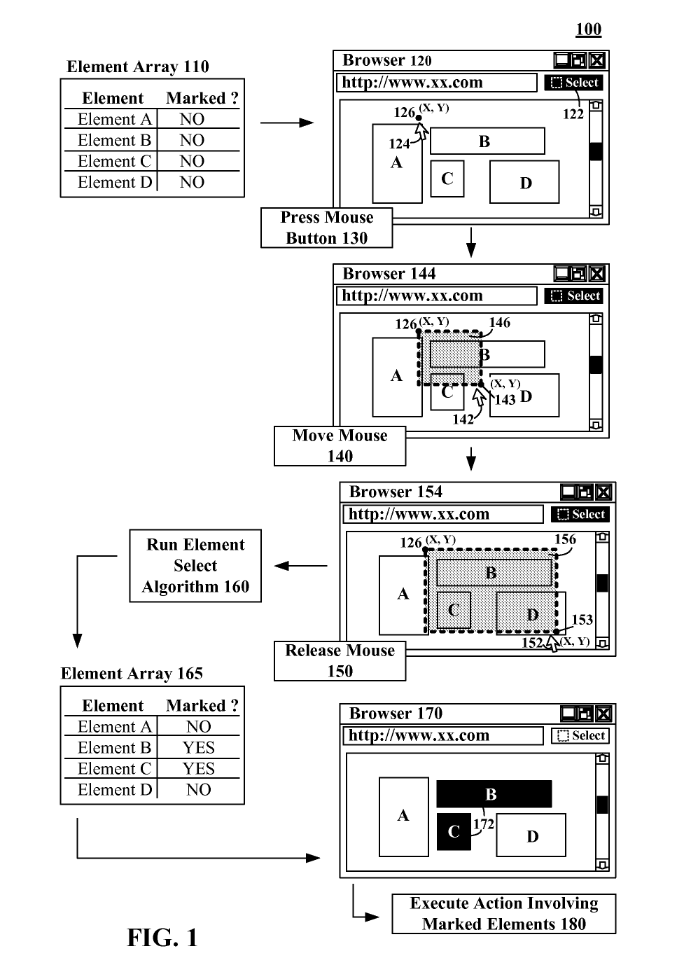

FIG. 1 is a diagram 100 showing a use of a region selection control for selecting browser elements in accordance with an embodiment of the inventive arrangements disclosed herein. In diagram 100, an element array 110 can be a software artifact associated with elements rendered in a browser interface 120. Array 110 indicates whether each element of interface 120 (e.g., Element A, Element B, Element C, and Element D) has been marked for selection or not. Initially, none of the array 110 elements can be marked for selection.

At this state, a user of browser 120 can enable a region selection tool 122. With this tool 122 enabled, a user can position a pointer 124 to a desired position within the browser 120 interface. The user can then press 130 a mouse button, which designates an initial point 126 in the interface.

Once this point 126 is identified, a user can move the pointer 142. Interface 144 shows a state of the selection region 146 when the pointer 142 is at an intermediate point 143. Interface 144 illustrates that the region 146 anchored at point 126 can be dynamically and visually shown as the mouse is moved (action 140). Region 146 can be visually demarcated in a fashion, such as by making the region 146 a semi-transparent, darkened region.

When a pointer 152 is positioned in a user desired location, such as terminal point 153, a user can release the mouse button 150, as shown by interface 154. Selection region 156 can be defined as a region having the initial point 126 as one corner and a terminal point 153 as an opposing corner.

At this point, an algorithm 160 can execute to determine which elements are contained within the selection region 156. As shown, Element A and Element D are partially outside the selection region 156, while Element B and Element C are completely inside the selection region 156. The element array 165 can be updated to reflect a set of elements contained in region 156. Element array 165 reflects this updating by showing Element B and Element C marked as selected, where Element A and Element D remain unmarked.

Visually, the interface 154 can be updated once the element array 165 has been updated. As shown by interface 170, the selected elements (Element B and C) can be visually shown as being selected, such as by highlighting 172 each selected element.

A user can then optionally change which elements are selected. For example, a user can press a “shift key” to select non-selected elements (adding them to the selection set) or can select a highlighted element with a “shift key” pressed to de-select it. The element array 165 can be updated accordingly. Any other mechanism can be used to alter a set of browser elements is marked as selected and the disclosure is not to be construed as limited to use of a “shift key” during alterations.

After being marked, any number of programmatic actions involving the marked elements 172 can be performed 180. Operations that use marked elements 172 can include, but are not limited to, a copy operation, a cut operation, a move operation, a save operation, and the like. Operations can include intra-application operations as well as inter-application operations. For example, an entire row or column of data in a table (assuming the row or column is a distinct element) can be selected and an application specific action (such as deleting the row/column or performing a data processing action based upon the row/column defined information) can be performed.

These performed actions can occur server side, by the server which provides the content rendered in the browser 170. Suitable messages can be conveyed between a client hosting the browser and the server (e.g., messages detailing which browser elements have been selected as well as which user initiated commands involving the actions are to execute.)

Local uses of the selection region can involve a clipboard memory and placing clipboard stored content within an application other than a Web browser. In any of these operations, structure of a selected browser element can be retained and utilized.

It should be noted that selection of discrete marked elements 172 different from current methodologies, which include taking a “snapshot” image of a portion of the screen that results in semantic content of elements being lost and an image segment (e.g., JPEG, BMP, etc.) being created. Further, unlike conventional “text” selection mechanisms, the element selection tool can operate on a browser element level of granularity. That is, an entire element (included tag information defining characteristics of the element) can be captured and utilized during the programmatic action 180. For example, if a table element is captured, formatting pertaining to columns, rows, and values of the table can be captured and used (i.e., if marked elements are pasted into word, actual structure based upon browser element structure can be included within the target document). Conventional content marking using a text selection tool, generally captures a stream of text, ignoring browser element boundaries and tags. No known technique permits a region based selection of browser elements on a browser element level as shown in diagram 100.

Diagram 100 is not to be limited to mouse based manipulations. That is, any type of device or technique for selecting points based upon a pointer position on a screen and for moving the pointer position can be used. For example, instead of a mouse, a trackball, joystick, touchpad, touch sensitive display, and the like can be used. Additionally, an array 110, 140 is one type of data structure able to maintain information about rendered elements, any other structure can be utilized to equivalent effect.

Although shown in diagram 100 as being dynamically drawn and displayed, the selection region can be implemented in other manners. For example, the selection region can be based upon multiple contact points (one representing point 126 another point 153) on a multi-touch surface. Additionally, the selection region need not be grayed out or semi-transparent, but can instead be represented in any visually distinct manner. For example, the selected region 153 can be a clear region marked in a characteristic outline.

In one embodiment, conditions to determine whether an element is to be considered “marked” by a selection region can be configured. One such configuration selects any element that is more than XX percent within the region. So that if XX was configured at seventy five percent (based upon interface 150) Element D can be considered within selection region 156, while Element A would still be considered outside the region 156. One configurable setting can disqualify nested elements from selection when the parent element is at least partially outside the selection region. Another configurable setting can include child elements for selection, even when parent elements are at least partially outside the selection region.

The principle salient characteristic of diagram 100 is that a selection region can be established and that all browser elements “contained within” (however defined) that region can be marked as selected. Browser elements can include any render-able element, regardless of whether it was statically or dynamically defined. Browser elements (Elements A-D) can include HTML elements, tables, pictures, text regions, media interface controls, and the like.

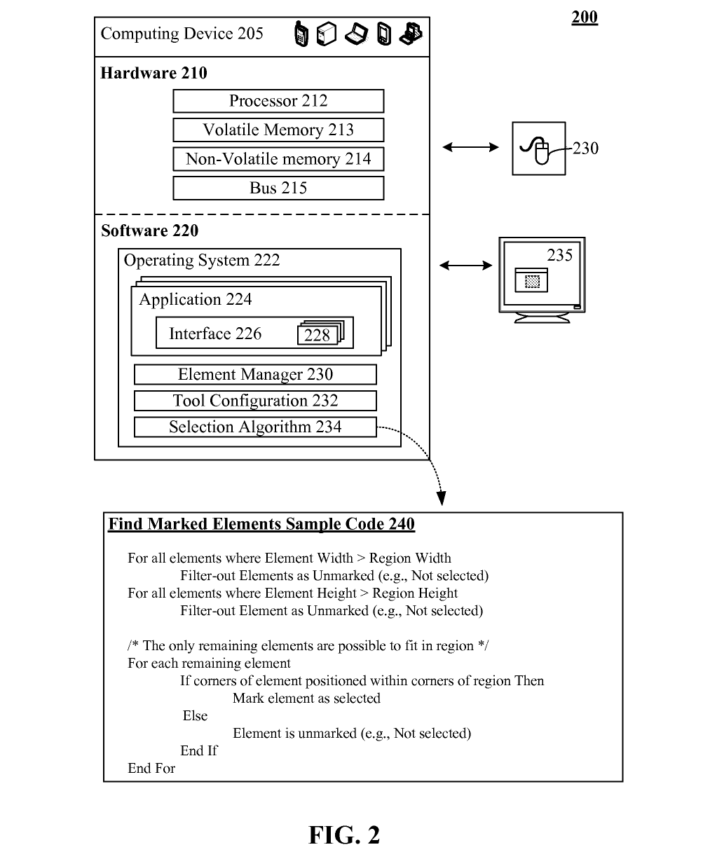

FIG. 2 is a schematic diagram illustrating a system 200 that implements a region selection control for browser elements within a graphical user interface in accordance with an embodiment of the inventive arrangements disclosed herein. System 200 shows a computing device 205 having a pointer control peripheral 230 and a visual display 235. The computing device 205 can include hardware 210 and software 220. Firmware (not shown) is also contemplated for device 210, which is an alternative embodiment for implementing any computer program products and program artifacts, such as those 222-234 illustrated as being implemented within software 220.

The hardware 210 can include a processor 212, a volatile memory 213, and a nonvolatile memory 214, which are interconnected by a bus 215. The software 220 can be digitally encoded on the non-volatile memory 214, which is the case for client-side software executables. The software 220 can also be served from one or more remote locations, such as with Web services, in which case the software 220 may be placed within the volatile memory 213 during execution and may be absent from the non-volatile memory 214.

Regardless, the software 220 can include an operating system 222, and one or more applications 224. The applications 224 can include a graphical user interface (GUI) 226, which in turn includes one or more interactive controls 228. The application 224 can be a browser, a rich internet interface, a Web-enabled gadget, and the like. The GUI 226 and GUI ones of the controls 228 can be visually presented upon display 235. The computing device 210 can include additional components, peripherals, and interface types (e.g., voice user interfaces, multimodal interfaces, etc.), which are not elaborated upon due to the focus of system 200, which is for a novel GUI control.

More specifically, the novel GUI control 228 can be a region selection control for browser elements. Software 220 specific to this region selection control can include an element manager 230, a tool configuration component 232, and a selection algorithm 234. Although shown as being implemented as an operating system 222 level, one or more of these components 230-234 for the region selection control can alternatively be implemented within browser (application 224) code.

The element manager 230 can maintain a current list of interface elements that are “selected” or marked. Any of a variety of programmatic action (e.g., cut, copy, paste, save, move, delete, etc.) can be performed against currently selected interface elements. The tool configuration component 232 can permit a user to configure specifics regarding a manner in which a region selection tool is to behave. In one embodiment, a user can configure whether or not children of parent browser elements are to be considered distinct “selectable” elements. In another embodiment, a user can configure criteria for determining whether an interface element is within a user selected region.

Selection algorithm 234 can be code used to select which of a set of browser elements, if any, are considered within a region. Although any algorithm 234 can be used to scan for browser elements included in a selection region, brute force algorithms 234 may suffer performance degradations as an area of the selection region increases. Sample code 240 can initially filters out browser elements not able to be contained within a selection region, which can significantly reduce processing times.

The sample code 240 can first filters out browser elements too wide or too long to be able to be contained within a selection region. This filtering can save significant processing time, as more detailed calculations need not be considered for those elements that have been filtered out of the selection process. In one embodiment (not shown), child elements (or some child elements depending upon configured settings of a region selection tool) can be filtered out when their parent element is filtered out. Different types of elements can exhibit different behavior. For example, text type elements can permit only a portion of text of a browser element to be selected, while graphical elements can require an entire portion of the element before selection is permitted. Similarly, some types of parent elements (e.g., tables) can permit one type of child element (e.g., row or column) to be selected, but not smaller elements (e.g., table cell). In one embodiment, exact behavior used by the selection algorithm 234 can be selectively configured using component 232.

When only browser elements able to fit in a selection region remain, the four corners of these elements can be compared against the four corners of the selection region to determine if the browser elements are inside the selection region. If so, the browser element is consider marked, otherwise the browser element is unmarked.

As used herein, a browser element can represent any discretely definable element render-able within a browser. The browser element can be defined by static markup code and/or dynamic markup code. A typical browser element can be an HTML element.

The computing device 205 can include any computing device which permits user interaction through a graphical user interface 226. In one embodiment, the graphical user interface 226 can be a visual mode of a multi-modal user interface. The computing device 205 can include, but is not limited to, a personal computer, a mobile phone, a media player, an electronic gaming console, a consumer electronic device, a wearable computer, a navigation device, a personal data assistant, a kiosk, an embedded computing system, and the like.

The pointer control peripheral 230 can include any of a variety of devices able to accept input to move a pointer within a graphical user interface in a user designated manner. The pointer control peripheral can include, for example, a mouse, a trackball, a pointing stick, a touchpad, a joystick, a set of position specific buttons, and the like.

The display 235 can include any component or device able to visually present a graphical user interface. The display 235 can include a monitor, an embedded screen, a video projector, a holographic projector, and the like.

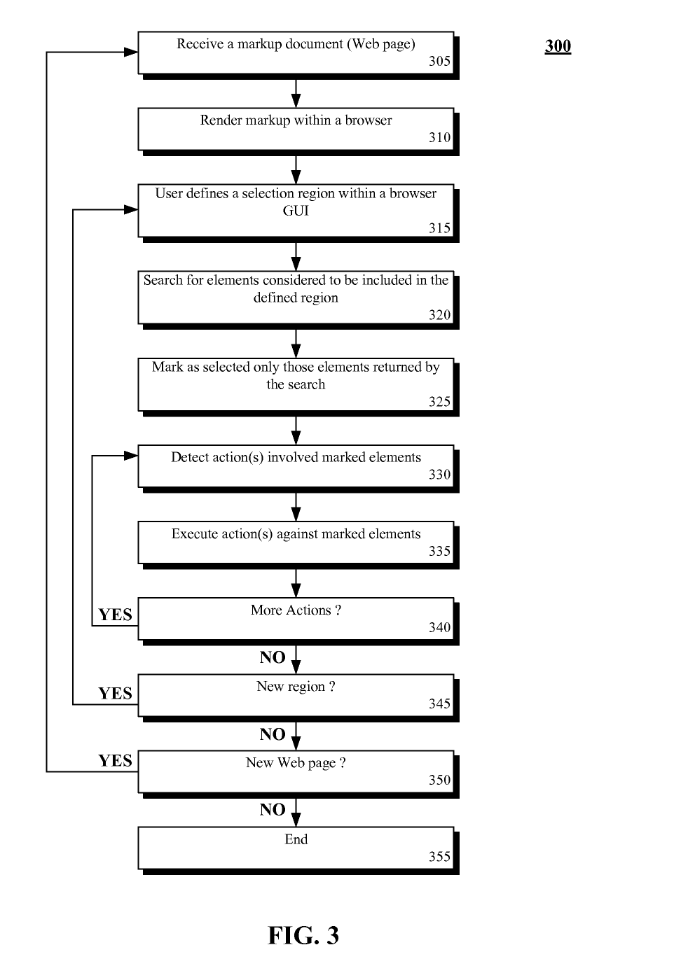

FIG. 3 is a flow chart showing a region selection method 300 in accordance with an arrangement of the inventive arrangements disclosed herein. The method 300 can be performed in context of a system 200, or similar system.

Method 300 can begin in step 305, where a markup document (e.g., a Web page) can be received. This page can be rendered within a browser in step 310. In step 315, a user can define a selection region within a browser's GUI. For example, the user can press a mouse button at an initial point, move a pointer to a final point, and release the mouse button. A rectangular region between the initial and final point can represent a selection region.

In step 320, a search can be performed for browser elements considered as included within the selection region. In step 325, only those browser elements returned by the search can be marked as selection. The set of marked browser elements can be optionally altered at this stage through any GUI mechanism. For example, an additional browser element can be added to the marked group by holding the “shift key” while clicking on an element. In another example, a browser element indicated within the GUI interface as marked can be unmarked, such as by holding the “shift key” while clicking on the element.

In step 330, a programmatic action can be detected that involves using the marked elements. In step 335, these programmatic actions can be executed. For example, the marked objects can be cut, copied, deleted, and the like. In step 340, a check for more actions involving the marked items can be made. More actions can execute as appropriate involving the marked elements (shown by progressing from step 340 to step 330).

When no additional actions are needed, step 345 can execute, where a check for a different user selected region can be made. For example, a user can repeat a region selection process for a different region, which is shown by progressing from step 345 to step 315. If no new region is defined, step 350 can execute, where a new Web page (progressing from step 350 to step 305) can be optionally loaded. When no new Web page is to be loaded in the browser, the method can end in step 355.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for selecting content within a browser comprising:
identifying an initial point within a browser interface corresponding to a displayed pointer location;
identifying a terminal point within the browser interface corresponding to a final position of the pointer;
defining a selection region where the initial point and the terminal point are diagonally opposing corners of the selection region;
searching a plurality of browser elements for elements that are defined by the selection region to produce a set of resulting browser elements; and
marking the set of resulting browser elements as selected.

2. The method of claim 1, further comprising:
visually demarcating the browser elements included in the set of resulting browser elements from other ones of the elements contained in the browser interface.

3. The method of claim 1, further comprising:
visually showing the selection region as a demarcated region of the browser interface.

4. The method of claim 1, further comprising:
receiving user input from a pointing device, wherein the user input defines the initial point and the terminal point.

5. The method of claim 1, wherein each browser element in the set of resulting browser elements is completely contained within the selection region.

6. The method of claim 5, further comprising:
filtering browser elements from the plurality during the searching that have an associated height greater than a height of the selection region;
filtering browser elements from the plurality during the searching that have an associated width greater than a width of the selection region; and
comparing corner points of those browser elements of the plurality that remain after the filtering of elements to determine whether the corner points are within the selection region.

7. The method of claim 1, further comprising:
receiving a user command associated with performing a programmatic operation involving the set of resulting elements that have been marked as selected; and
executing the programmatic operation involving the set of resulting elements.

8. The method of claim 7, wherein the selection region of the browser interface is a region of a Web application serviced from a Web server, wherein said programmatic action is an intra-application programmatic action, said method further comprising:
conveying the user command and an identifier for each element in the set of resulting elements to a Web server associated with the Web application, wherein the Web server executes the programmatic operation involving the set of resulting elements; and
conveying results of the executing from the Web server to a client upon which the browser interface is presented.

9. The method of claim 7, wherein said browser interface is an interface of a Web browser executing upon a client, said method further comprising:
capturing content within a clipboard memory of the client corresponding to the resulting set of browser elements, wherein within the clipboard memory structure of each browser element is maintained; and
during the programmatic operation, placing captured content of the clipboard memory into an application executing upon the client that is an application other than said Web browser.

10. A computer program product for selecting content within a browser comprising:
a computer usable medium having computer usable program code embodied therewith, the computer usable program code comprising:
computer usable program code configured to identity an initial point within a browser interface corresponding to a displayed pointer location;
computer usable program code configured to identify a terminal point within the browser interface corresponding to a final position of the pointer;
computer usable program code configured to define a selection region where the initial point and the terminal point are diagonally opposing corners of the selection region;
computer usable program code configured to search a plurality of browser elements for elements that are defined by the selection region to produce a set of resulting browser elements; and
computer usable program code configured to mark the set of resulting browser elements as selected.

11. The computer program product of claim 10, further comprising:
computer usable program code configured to visually demarcate the browser elements included in the set of resulting browser elements from other ones of the elements contained in the browser interface.

12. The computer program product of claim 10, further comprising:
computer usable program code configured to visually show the selection region as a demarcated region of the browser interface.

13. The computer program product of claim 10, further comprising:
computer usable program code configured to receive user input from a pointing device, wherein the user input defines the initial point and the terminal point.

14. The computer program product of claim 10, wherein each browser element in the set of resulting browser elements is completely contained within the selection region.

15. The computer program product of claim 14, further comprising:
computer usable program code configured to filter browser elements from the plurality during the searching that have an associated height greater than a height of the selection region;
computer usable program code configured to filter browser elements from the plurality during the searching that have an associated width greater than a width of the selection region; and
computer usable program code configured to compare corner points of those browser elements of the plurality that remain after the filtering of elements to determine whether the corner points are within the selection region.

16. The computer program product of claim 10, further comprising:
computer usable program code configured to receive a user command associated with performing a programmatic operation involving the set of resulting elements that have been marked as selected; and
computer usable program code configured to execute the programmatic operation involving the set of resulting elements.

17. The computer program product of claim 16, wherein the selection region of the browser interface is a region of a Web application serviced from a Web server, wherein said programmatic action is an intra-application programmatic action, said computer program product further comprising:
computer usable program code configured to convey the user command and an identifier for each element in the set of resulting elements to a Web server associated with the Web application, wherein the Web server executes the programmatic operation involving the set of resulting elements; and
computer usable program code configured to convey results of the executing from the Web server to a client upon which the browser interface is presented.

18. The computer program product of claim 16, wherein said browser interface is an interface of a Web browser executing upon a client, said computer program product further comprising:
computer usable program code configured to capture content within a clipboard memory of the client corresponding to the resulting set of browser elements, wherein within the clipboard memory structure of each browser element is maintained; and
computer usable program code configured to during the programmatic operation, place captured content of the clipboard memory into an application executing upon the client that is an application other than said Web browser.
